(19) United States
(12) Patent Application Publication
(10) Pub. No.: US 2020/0310675 A1
(43) Pub. Date: Oct. 1, 2020

(54) MEMORY SYSTEM AND METHOD OF OPERATING THE SAME

(71) Applicant: SK hynix Inc., Gyeonggi-do (KR)

(72) Inventor: Sung Yeob CHO, Gyeonggi-do (KR)

(21) Appl. No.: 16/591,325

(22) Filed: Oct. 2, 2019

(30) Foreign Application Priority Data
Mar. 28, 2019 (KR) 10-2019-0036356

(51) Int. Cl. G06F 3/06; G06F 12/0868; G06F 12/02; G06F 13/16

(52) U.S. Cl. CPC G06F 3/0656; G06F 3/0659; G06F 3/0608; G06F 3/0679; G06F 2212/401; G06F 12/0868; G06F 12/0246; G06F 13/1673; G06F 2212/7201; G06F 3/064

(57) ABSTRACT

Provided herein may be a memory system and a method of operating the same. A memory system may include a controller configured to generate a compressed data segment by compressing certain data segments, among a plurality of data segments received from a host, and a memory device configured to receive and store the compressed data segment, wherein the controller is further configured to detect compression information of each of the plurality of data segments, and wherein the controller groups together and compresses the certain data segments based on the compression information.

### CROSS-REFERENCE TO RELATED APPLICATION

The present application claims priority under 35 U.S.C. § 119(a) to Korean patent application number 10-2019-0036356, filed on Mar. 28, 2019, which is incorporated herein by reference in its entirety.

### BACKGROUND

### Field of Invention

Various embodiments of the present disclosure relate generally to an electronic device, and, more particularly, to a memory system and a method of operating the memory system.

### Description of Related Art

Recently, the paradigm for a computer environment has been converted into ubiquitous computing so that computer systems can be used anytime and anywhere. Due to this, use of portable electronic devices such as mobile phones, digital cameras, and notebook computers has rapidly increased. Generally, portable electronic devices use a memory system which employs a memory device for storing data, i.e., as a data storage device. The memory device may be used as a main memory device or an auxiliary memory device for portable electronic devices.

Memory devices provide substantial advantages over non-semiconductor based data storage devices because they do not have any mechanical driving parts, and, hence, provide improved stability and durability, increased information access speed, and reduced power consumption. Examples of the memory system having such advantages, include a universal serial bus (USB) memory device, memory cards having various interfaces, and a solid state drive (SSD).

Memory devices are chiefly classified into volatile and nonvolatile memory devices.

The nonvolatile memory device has comparatively low write and read speed, but retains data stored therein even when the supply of power is interrupted. Therefore, the nonvolatile memory device is used to store data which must be retained regardless of whether power is supplied. Representative examples of the nonvolatile memory device include a read-only memory (ROM), a mask ROM (MROM), a programmable ROM (PROM), an erasable programmable ROM (EPROM), an electrically erasable programmable ROM (EEPROM), a flash memory, a phase-change random access memory (PRAM), a magnetic RAM (MRAM), a resistive RAM (RRAM), and a ferroelectric RAM (FRAM). The flash memory is classified into a NOR type and a NAND type.

### SUMMARY

Various embodiments of the present disclosure are directed to a memory system that is capable of compressing and storing write data received from a host and a method of operating the memory system.

An embodiment of the present disclosure may provide for a memory system. The memory system may include a controller configured to generate a compressed data segment by compressing certain data segments, among a plurality of data segments received from a host; and a memory device configured to receive and store the compressed data segment, wherein the controller is further configured to detect compression information of each of the plurality of data segments, and wherein the controller groups together and compresses the certain data segments based on the compression information.

An embodiment of the present disclosure may provide for a method of operating a memory system. The method may include, detecting compression information of the data segment when a write command and a data segment are received from a host; generating a command queue corresponding to the write command; grouping, based on the compression information of the data segment and pieces of compression information of previous data segments that have been received before the data segment is received, the data segment with certain data segments among the previous data segments; generating a compressed data segment by compressing the grouped data segments; and storing the compressed data segment in a memory device in response to the command queue.

An embodiment of the present disclosure may provide for a method of operating a memory system. The method may include receiving a read command and a logical address from a host and generating a command queue in response to the read command; checking, based on a mapping table, a physical address of a data segment corresponding to the logical address, information about whether a compression operation of compressing the data segment has been performed during a program operation to the data segment, information about a position of the data segment in a compressed data segment, and information about a compression class of the data segment; reading the compressed data segment stored in a memory device in response to the command queue and the physical address; and decompressing the data segment corresponding to the logical address from the compressed data segment based on the information about the position.

An embodiment of the present disclosure may provide for a method of operating a controller for controlling a memory device. The method may include generating a compressed segment having a size of a write data unit by compressing a group of buffered write data segments respectively according to compression classes of the write data segments; and controlling the memory device to store therein the compressed segment.

These and other advantages and features of the present invention will be better understood from the following description of specific embodiments of the invention in conjunction with the following drawings.

### BRIEF DESCRIPTION OF THE DRAWINGS

FIG. 1 is a block diagram illustrating a memory system according to an embodiment of the present disclosure.

FIG. 2 is a block diagram illustrating a configuration of a controller of FIG. 1 according to an embodiment of the present disclosure.

FIG. 3 is a block diagram of a semiconductor memory of FIG. 1 according to an embodiment of the present disclosure.

FIG. 4 is a circuit diagram illustrating a memory block of FIG. 3 according to an embodiment of the present disclosure.

FIG. 5 is a diagram illustrating an example of a memory block having a 3D structure according to an embodiment of the present disclosure.

FIG. 6 is a diagram illustrating an example of a memory block having a 3D structure according to an embodiment of the present disclosure.

FIG. 7 is a diagram illustrating data segments received from a host according to an embodiment of the present disclosure.

FIG. 8 is a diagram illustrating a compressed data segment according to an embodiment of the present disclosure.

FIG. 9 is a diagram escribing compression classes depending on data compressibility according to an embodiment of the present disclosure.

FIG. 10 is a diagram describing data segment management information according to an embodiment of the present disclosure.

FIG. 11 is a diagram describing a mapping table according to an embodiment of the present disclosure.

FIG. 12 is a diagram illustrating a data flow during a write operation according to an embodiment of the present disclosure.

FIG. 13 is a flowchart of a write operation of a memory system according to an embodiment of the present disclosure.

FIG. 14 is a diagram illustrating a data flow during a read operation.

FIG. 15 is a flowchart of a read operation of a memory system according to an embodiment of the present disclosure.

FIG. 16 is a diagram illustrating an embodiment of a memory system.

FIG. 17 is a diagram illustrating an embodiment of a memory system.

FIG. 18 is a diagram illustrating an embodiment of a memory system.

FIG. 19 is a diagram illustrating an embodiment of a memory system.

### DETAILED DESCRIPTION

Specific structural or functional descriptions in the embodiments of the present disclosure introduced in this specification or application are only for description of the embodiments of the present disclosure. The descriptions should not be construed as being limited to the embodiments described in the specification or application.

The present disclosure will now be described in detail based on specific embodiments. The present disclosure may, however, be embodied in many different forms and should not be construed as being limited to only the embodiments set forth herein, but should be construed as covering modifications, equivalents or alternatives falling within ideas and technical scopes of the present disclosure. However, this is not intended to limit the present disclosure to particular modes of practice, and it is to be appreciated that all changes, equivalents, and substitutes that do not depart from the spirit and technical scope of the present disclosure are encompassed in the present disclosure.

It will be understood that, although the terms “first” and/or “second” may be used herein to describe various elements, these elements should not be limited by these terms. These terms are only used to distinguish one element, from another element. For instance, a first element discussed below could be termed a second element without departing from the teachings of the present disclosure. Similarly, the second element could also be termed the first element.

It will be understood that when an element is referred to as being “coupled” or “connected” to another element, it can be directly coupled or connected to the other element or intervening elements may be present therebetween. In contrast, it should be understood that when an element is referred to as being “directly coupled” or “directly connected” to another element, there are no intervening elements present. Other expressions that describe the relationship between elements, such as “between”, “directly between”, “adjacent to” or directly adjacent to” should be construed in the same way.

The terminology used herein is for the purpose of describing particular embodiments only and is not intended to be limiting. In the present disclosure, the singular forms are intended to include the plural forms as well, unless the context clearly indicates otherwise. It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Unless otherwise defined, all terms including technical and scientific terms used herein have the same meaning as commonly understood by one of ordinary skill in the art to which the present disclosure belongs. It will be further understood that terms used herein should be interpreted as having a meaning that is consistent with their meaning in the context of this specification and the relevant art and will not be interpreted in an idealized or overly formal sense unless expressly so defined herein.

Detailed description of functions and structures well known to those skilled in the art will be omitted to avoid obscuring the subject matter of the present disclosure. This aims to omit unnecessary description so as to make the gist of the present disclosure clear.

Embodiments of the present disclosure are described with reference to the accompanying drawings in order to describe the present disclosure in detail so that those having ordinary knowledge in the technical field to which the present disclosure pertains can easily practice the present disclosure.

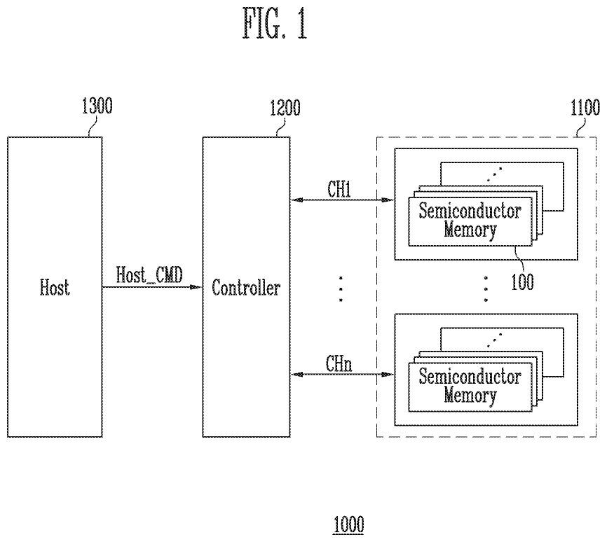

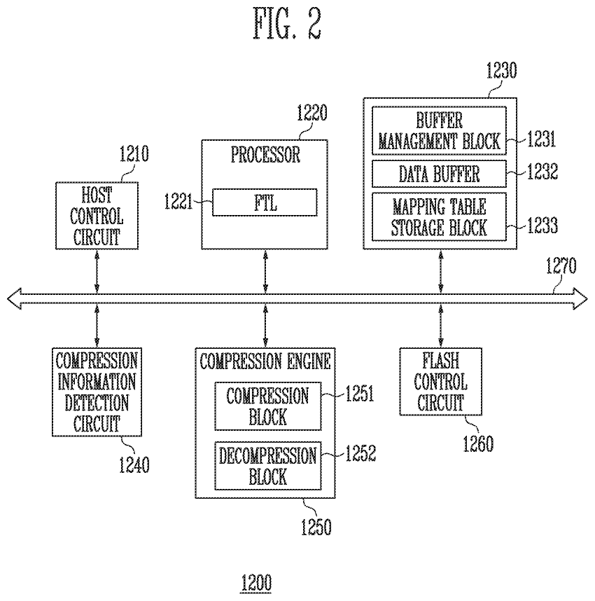

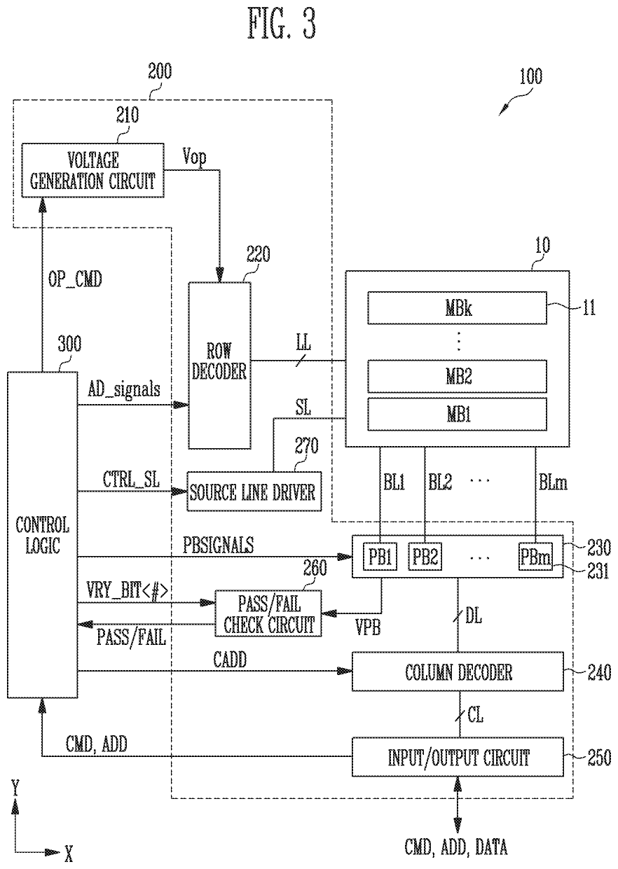

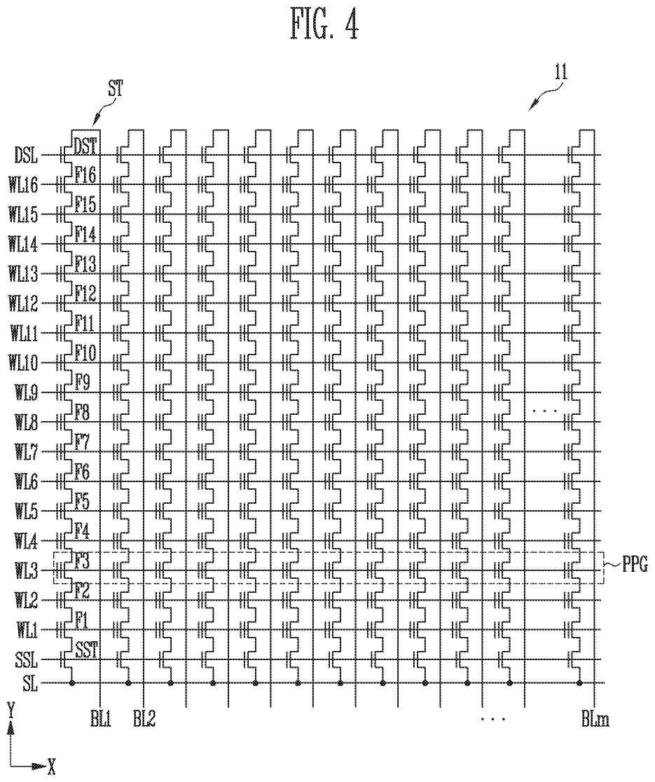

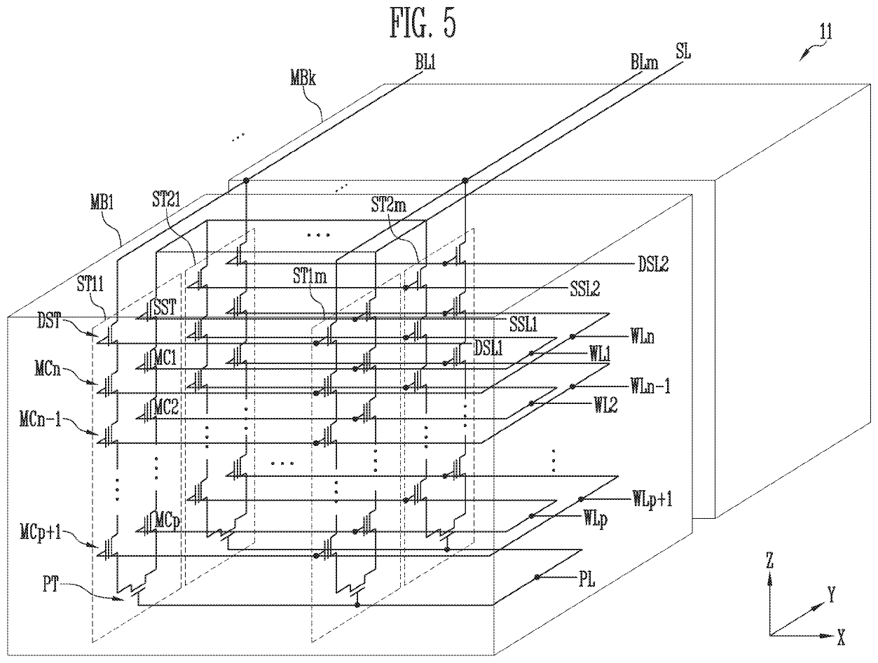

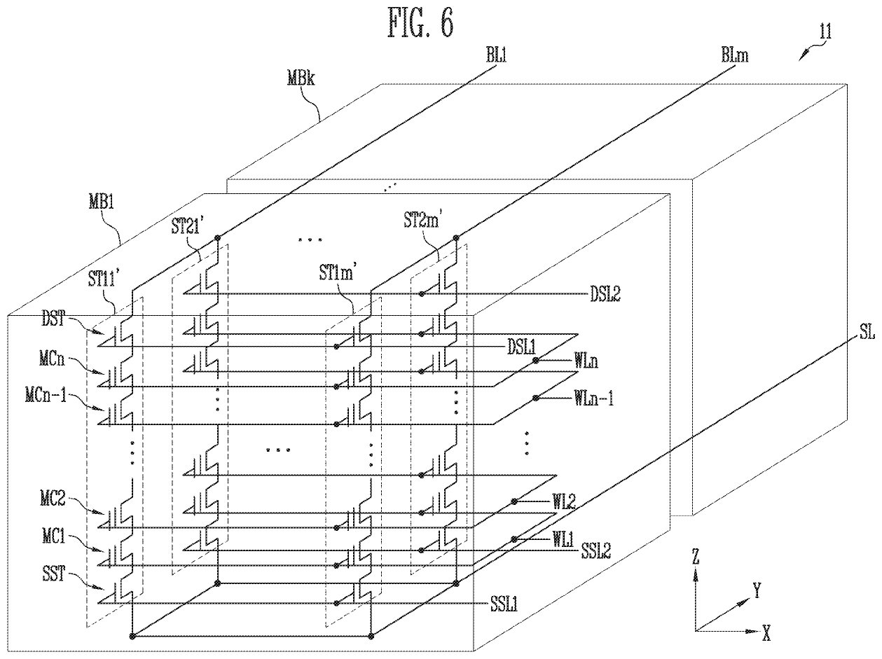

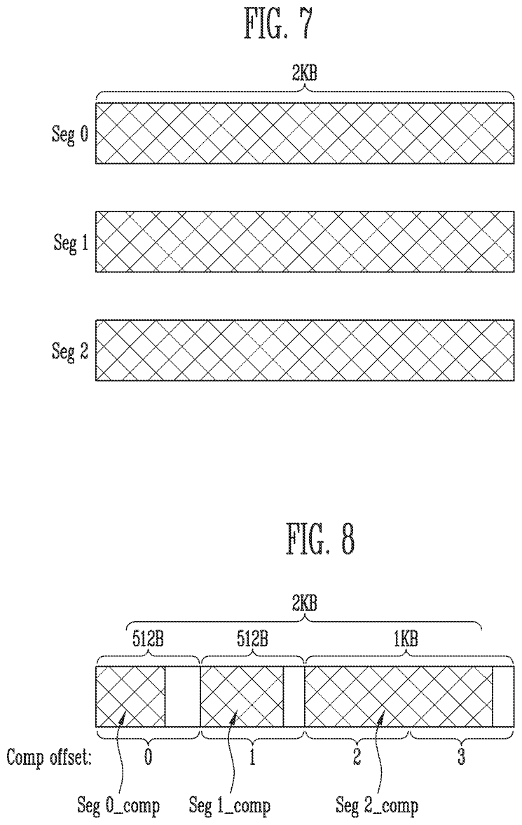

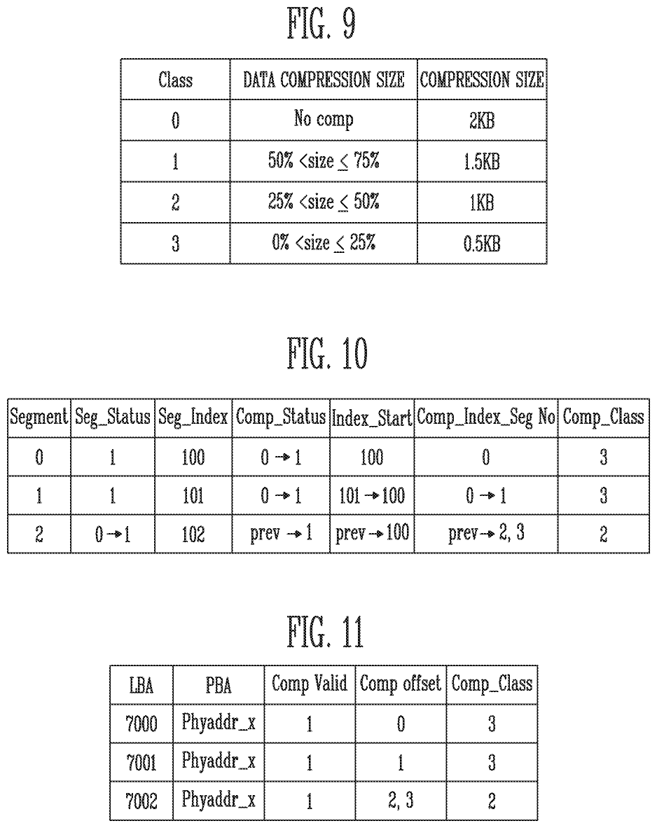

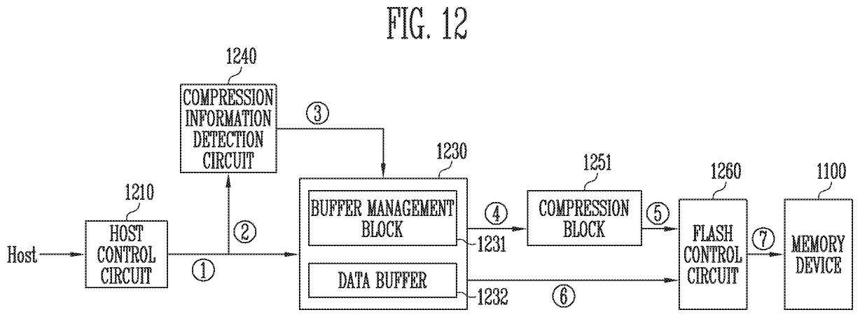

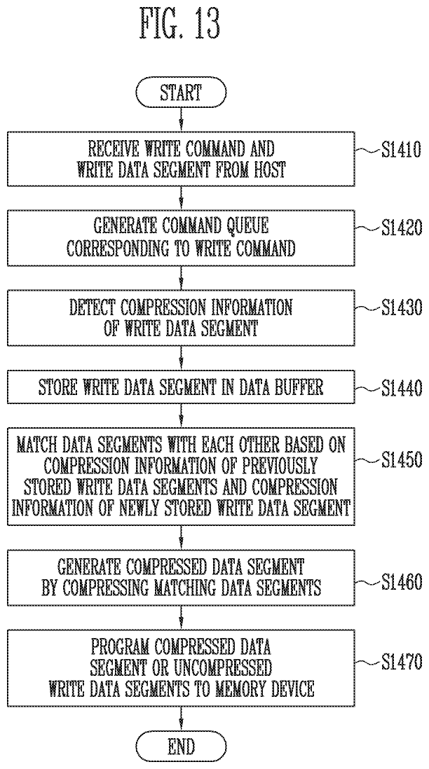

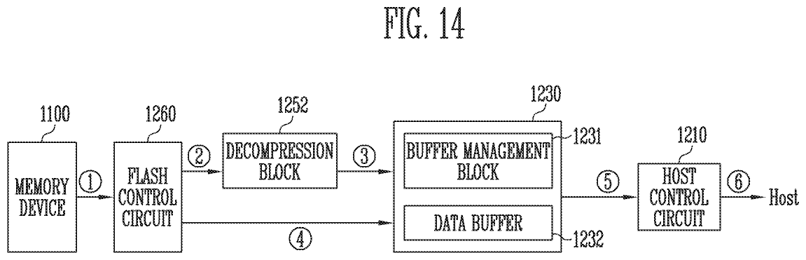

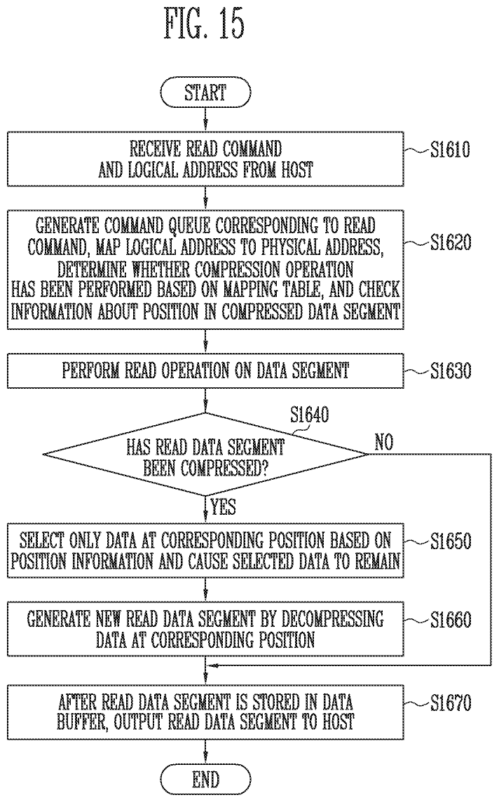

FIG. 1 is a block diagram illustrating a memory system according to an embodiment of the present disclosure.

Referring to FIG. 1, a memory system 1000 may include a memory device 1100, a controller 1200, and a host 1300. The memory device 1100 may include a plurality of semiconductor memories 100. The plurality of semiconductor memories 100 may be divided into a plurality of groups. In an embodiment of the present disclosure, although the host 1300 is illustrated and described as being included in the memory system 1000, the memory system 1000 may be configured to include only the controller 1200 and the memory device 1100, and the host 1300 may be arranged outside the memory system 1000.

In FIG. 1, the plurality of groups of the memory devices 1100 may communicate with the controller 1200 through first to n-th channels CH1 to CHn, respectively. Each semiconductor memory 100 will be described in detail later with reference to FIG. 3.

Each of the plurality of groups configured using the semiconductor memories 100 may individually communicate with the controller 1200 through a single common channel. The controller 1200 may control the semiconductor memories 100 of the memory device 1100 through the plurality of channels CH1 to CHn.

The controller 1200 is coupled between the host 1300 and the memory device 1100. The controller 1200 may access the memory device 1100 in response to a request from the host 1300. For example, the controller 1200 may control a read operation, a write operation, an erase operation, and a background operation of the memory device 1100 in response to a host command Host_CMD received from the host 1300. The host 1300 may transmit data segments and a logical address together with the host command Host_CMD during a write operation, and may transmit a logical address together with the host command Host_CMD during a read operation. The controller 1200 may provide an interface between the memory device 1100 and the host 1300. The controller 1200 may run firmware for controlling the memory device 1100.

During a write operation, the controller 1200 may detect pieces of compression information of the data segments received from the host 1300 and group the data segments based on the detected compression information. Further, the controller 1200 may generate a compressed data segment by compressing the grouped data segments and transmit the compressed data segment to the memory device 1100.

Also, during a read operation, the controller 1200 may map the logical address received from the host 1300 to a physical address, and may control the memory device 1100 so that a data segment corresponding to the mapped physical address is read. The controller 1200 may check the compression information of read data segments, decompress only data corresponding to the logical address, among the read data segments, and transmit the read data segment to the host 1300.

The host 1300 may include a portable electronic device, such as a computer, a personal digital assistant (PDA), a portable multimedia player (PMP), an MP3 player, a camera, a camcorder, or a mobile phone. The host 1300 may request a write operation, a read operation or an erase operation of the memory system 1000 through the host commands Host_CMD. The host 1300 may transmit a host command Host_CMD corresponding to a write command, a data segment, and a logical address to the controller 1200 so as to perform a write operation of the memory device 1100, and may transmit a host command Host_CMD corresponding to a read command and a logical address to the controller 1200 so as to perform a read operation of the memory device 1100.

The controller 1200 and the memory device 1100 may be integrated into a single semiconductor device. In an exemplary embodiment, the controller 1200 and the memory device 1100 may be integrated into a single semiconductor device to form a memory card. For example, the controller 1200 and the memory device 1100 may be integrated into a single semiconductor device to form a memory card, such as a personal computer memory card international association (PCMCIA), a compact flash card (CF), a smart media card (SM or SMC), a memory stick, a multimedia card (MMC, RS-MMC, or MMCmicro), an SD card (SD, miniSD, microSD, or SDHC), or a universal flash storage (UFS).

The controller 1200 and the memory device 1100 may be integrated into a single semiconductor device to form a solid state drive (SSD). The SSD includes a storage device configured to store data in each semiconductor memory 100.

In an embodiment, the memory system 1000 may be provided as one of various elements of an electronic device such as a computer, an ultra mobile PC (UMPC), a workstation, a net-book, a personal digital assistants (PDA), a portable computer, a web tablet, a wireless phone, a mobile phone, a smart phone, an e-book, a portable multimedia player (PMP), a game console, a navigation device, a black box, a digital camera, a three-dimensional (3D) television, a digital audio recorder, a digital audio player, a digital picture recorder, a digital picture player, a digital video recorder, a digital video player, a device capable of transmitting/receiving information in an wireless environment, one of various devices for forming a home network, one of various electronic devices for forming a computer network, one of various electronic devices for forming a telematics network, an RFID device, one of various elements for forming a computing system, or the like.

In an exemplary embodiment, the memory device 1100 or the memory system 1000 may be mounted in various types of packages. For example, the memory device 1100 or the memory system 1000 may be packaged and mounted in a package type such as Package on Package (PoP), Ball grid arrays (BGAs), Chip scale packages (CSPs), Plastic Leaded Chip Carrier (PLCC), Plastic Dual In Line Package (PDIP), Die in Waffle Pack, Die in Wafer Form, Chip On Board (COB), Ceramic Dual In Line Package (CERDIP), Plastic Metric Quad Flat Pack (MQFP), Thin Quad Flatpack (TQFP), Small Outline (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), Wafer-Level Processed Stack Package (WSP), or the like.

FIG. 2 is a block diagram illustrating a configuration of the controller of FIG. 1 according to an embodiment of the present disclosure.

Referring to FIG. 2, the controller 1200 may include a host control circuit 1210, a processor 1220, a buffer memory 1230, a compression information detection circuit 1240, a compression engine 1250, a flash control circuit 1260, and a bus 1270.

The bus 1270 may provide a channel between components of the controller 1200.

The host control circuit 1210 may control data transmission between the host 1300 of FIG. 1 and the buffer memory 1230. In an example, the host control circuit 1210 may control an operation of buffering write data segments from the host 1300, in the buffer memory 1230. In an example, the host control circuit 1210 may control an operation of outputting read data segments, buffered in the buffer memory 1230, to the host 1300.

The host control circuit 1210 may include a host interface.

The processor 1220 may control the overall operation of the controller 1200 and perform a logical operation. The processor 1220 may communicate with the host 1300 of FIG. 1 through the host control circuit 1210, and may communicate with the memory device 1100 of FIG. 1 through the flash control circuit 1260. Further, the processor 1220 may control the operation of a memory system 1000 by using the buffer memory 1230 as a working memory, a cache memory or a buffer. The processor 1220 may generate a command queue by rearranging a plurality of host commands, received from the host 1300, depending on the priorities thereof, and may then control the flash control circuit 1260 based on the command queue. The processor 1220 may include a flash translation layer (hereinafter referred to as an “FTL”) 1221.

The FTL 1221 may be operated based on firmware, and the firmware may be stored in the buffer memory 1230, an additional memory (not illustrated) directly coupled to the processor 1220, or a storage space in the processor 1220. The FTL 1221 may map a physical address, corresponding to an address (e.g., a logical address) input from the host 1300 of FIG. 1, to the logical address based on a mapping table during a write operation. Also, the FTL 1221 may check a physical address mapped to a logical address input from the host 1300 based on the mapping table during a read operation. The mapping table may be stored in the buffer memory 1230.

Further, the FTL 1221 may generate a command queue for controlling the flash control circuit 1260 in response to a host command received from the host 1300.

The buffer memory 1230 may be used as the working memory, the cache memory, or the buffer of the processor 1220. The buffer memory 1230 may store codes and commands that are executed by the processor 1220. The buffer memory 1230 may store data that is processed by the processor 1220. The buffer memory 1230 may store write data segments received from the host 1300 through the host control circuit 1210, and may store read data segments received through the flash control circuit 1260 or the compression engine 1250.

The buffer memory 1230 may include a buffer management block 1231, a data buffer 1232, and a mapping table storage block 1233.

The buffer management block 1231 may manage management information about a plurality of data segments stored in the data buffer 1232 and group data segments in a compression operation based on the management information. For example, during a write operation, the buffer management block 1231 may receive the compression information of write data segments from the host 1300, and may group some of write data segments, previously received and stored, with data segments, on which a compression operation is to be performed together, based on the received compression information. The operation of grouping data segments may be preferably performed to select a plurality of data segments and group them in such a way that the sum of compressed sizes of the grouped data segments is a size of a program data unit (e.g., 2 KB) of the memory device.

The data buffer 1232 may store a plurality of data segments, and may assign indices to spaces in which respective data segments are stored. The data buffer 1232 may be divided into a write buffer and a read buffer, wherein the write buffer may store write data segments received from the host 1300 during a write operation, and thereafter output the write data segments to the compression engine 1250 or the flash control circuit 1260 depending on whether it is possible to perform the compression operation of compressing the write data segments. During a read operation, the read buffer may temporarily store read data segments, received through the flash control circuit 1260 or the compression engine 1250, and may transmit the temporarily stored read data segments to the host 1300.

The mapping table storage block 1233 may store a mapping table which includes mapping information between logical addresses and physical addresses, information about compression or non-compression, a compression class, offset information, etc. of data corresponding to a logical address. The mapping table may be stored in the memory device 1100, and may be read from the memory device 1100 and stored in the mapping table storage block 1233 when a power-on operation of the memory system is performed.

The buffer memory 1230 may include a static RAM (SRAM) or a dynamic RAM (DRAM).

The compression information detection circuit 1240 may detect the compression information of the write data segments received from the host 1300 and transmit the compression information to the buffer memory 1230 during a write operation. The compression information may include information about whether the compression of write data segments is possible and information about a compression class.

The compression engine 1250 may include a compression block 1251 and a decompression block 1252.

During a write operation, the compression block 1251 may compress the grouped data segments, among a plurality of write data segments stored in the buffer memory 1230, and may generate a single compressed data segment. The compression block 1251 may compress the grouped data segments to an identical size or to different sizes depending on respective compression classes of the grouped data segments, and may generate the compressed data segment so that the sum of respective compressed data sizes of the grouped data segments is uniform (e.g., 2 KB). For example, the compression block 1251 may perform a data compression operation of compressing data segments, each having a data size of 2 KB, to a data size of 1.5 KB, 1 KB, or 512 B depending on respective compression classes of those data segments.

The decompression block 1252 may generate read data segments by decompressing the received compressed data segment during a read operation. The read data segments are transmitted to the buffer memory 1230.

The flash control circuit 1260 may generate and output an internal command for controlling the memory device 1100 in response to the command queue generated by the processor 1220. The flash control circuit 1260 may control the write operation by transmitting the data segments, which are buffered in the write buffer of the buffer memory 1230, or the compressed data segment, which is generated by the compression engine 1250, to the memory device 1100 during the write operation. In an embodiment, the flash control circuit 1260 may transmit the data segments read from the memory device 1100 to the buffer memory 1230 or to the compression engine 1250 in response to the command queue during the read operation.

The flash control circuit 1260 may include a flash interface.

FIG. 3 is a diagram illustrating a semiconductor memory 100 of FIG. 1 according to an embodiment of the present disclosure.

Referring to FIG. 3, the semiconductor memory 100 may include a memory cell array 10 in which data is stored. The semiconductor memory 100 may include peripheral circuits 200 configured to perform a program operation for storing data in the memory cell array 10, a read operation for outputting the stored data, and an erase operation for erasing the stored data. The semiconductor memory 100 may include a control logic 300 which controls the peripheral circuits 200 under the control of a controller (e.g., 1200 of FIG. 1).

The memory cell array 10 may include a plurality of memory blocks MB1 to MBk 11 (where k is a positive integer). Local lines LL and bit lines BL1 to BLm (where m is a positive integer) may be coupled to each of the memory blocks MB1 to MBk 11. For example, the local lines LL may include a first select line, a second select line, and a plurality of word lines arranged between the first and second select lines. Also, the local lines LL may include dummy lines arranged between the first select line and the word lines and between the second select line and the word lines. Here, the first select line may be a source select line, and the second select line may be a drain select line. For example, the local lines LL may include the word lines, the drain and source select lines, and source lines SL. For example, the local lines LL may further include dummy lines. For example, the local lines LL may further include pipelines. The local lines LL may be coupled to each of the memory blocks MB1 to MBk 11, and the bit lines BL1 to BLm may be coupled in common to the memory blocks MB1 to MBk 11. The memory blocks MB1 to MBk 11 may each be implemented in a two-dimensional (2D) or three-dimensional (3D) structure. For example, memory cells in the memory blocks 11 having a 2D structure may be horizontally arranged on a substrate. For example, memory cells in the memory blocks 11 having a 3D structure may be vertically stacked on the substrate.

The peripheral circuits 200 may perform program, read, and erase operations on a selected memory block 11 under the control of the control logic 300. For example, the peripheral circuits 200 may include a voltage generation circuit 210, a row decoder 220, a page buffer group 230, a column decoder 240, an input/output circuit 250, a pass/fail check circuit 260, and a source line driver 270.

The voltage generation circuit 210 may generate various operating voltages Vop that are used for program, read, and erase operations in response to an operation signal OP_CMD. Further, the voltage generation circuit 210 may selectively discharge the local lines LL in response to the operation signal OP_CMD. For example, the voltage generation circuit 210 may generate various voltages such as a program voltage, a verify voltage, a pass voltage, and a select transistor operating voltage under the control of the control logic 300.

The row decoder 220 may transfer the operating voltages Vop to the local lines LL coupled to the selected memory block 11 in response to control signals AD_signals. For example, the row decoder 220 may selectively apply the operating voltages (e.g., program voltage, verify voltage, pass voltage, etc.), generated by the voltage generation circuit 210, to the word lines of the local lines LL in response to row decoder control signals AD_signals.

The row decoder 220 may apply the program voltage, generated by the voltage generation circuit 210, to a selected word line of the local lines LL in response to the control signals AD_signals during a program voltage application operation, and may apply the pass voltage, generated by the voltage generation circuit 210, to the remaining word lines, that is, unselected word lines. Also, the row decoder 220 may apply the read voltage, generated by the voltage generation circuit 210, to a selected word line of the local lines LL in response to the control signals AD_signals during a read operation, and may apply the pass voltage, generated by the voltage generation circuit 210, to the remaining word lines, that is, unselected word lines.

The page buffer group 230 may include a plurality of page buffers PB1 to PBm 231 coupled to the bit lines BL1 to BLm. The page buffers PB1 to PBm 231 may be operated in response to the page buffer control signals PBSIGNALS. For example, the page buffers PB1 to PBm 231 may temporarily store data to be programmed during a program operation or may sense voltages or currents of the bit lines BL1 to BLm during a read or verify operation.

The column decoder 240 may transfer data between the input/output circuit 250 and the page buffer group 230 in response to a column address CADD. For example, the column decoder 240 may exchange data with the page buffers 231 through data lines DL or may exchange data with the input/output circuit 250 through column lines CL.

The input/output circuit 250 may transmit an internal command CMD and an address ADD, received from a controller (e.g., 1200 of FIG. 1), to the control logic 300, or may exchange data DATA with the column decoder 240. The address ADD may be a physical address.

During a read operation, the pass/fail check circuit 260 may generate a reference current in response to an enable bit VRY_VIT<#>, compare a sensing voltage VPB, received from the page buffer group 230, with a reference voltage, generated using the reference current, and then output a pass signal PASS or a fail signal FAIL.

The source line driver 270 may be coupled to memory cells included in the memory cell array 10 through a source line SL, and may control a voltage to be applied to the source line SL. The source line driver 270 may receive a source line control signal CTRL_SL from the control logic 300, and may control the source line voltage to be applied to the source line SL in response to the source line control signal CTRL_SL.

The control logic 300 may control the peripheral circuits 200 by outputting the operation signal OP_CMD, the control signals AD_signals, the page buffer control signals PBSIGNALS, and the enable bit VRY_BIT<#> in response to the internal command CMD and the address ADD. In addition, the control logic 300 may determine whether a verify operation has passed or failed in response to the pass or fail signal PASS or FAIL.

FIG. 4 is a circuit diagram illustrating the memory block of FIG. 3 according to an embodiment of the present disclosure.

Referring to FIG. 4, a memory block 11 may be configured such that a plurality of word lines, which are arranged in parallel, are coupled between a first select line and a second select line. Here, the first select line may be a source select line SSL and the second select line may be a drain select line DSL. In detail, the memory block 11 may include a plurality of strings ST coupled between bit lines BL1 to BLm and a source line SL. The bit lines BL1 to BLm may be respectively coupled to the strings ST, and the source line SL may be coupled in common to the strings ST. Since the strings ST may have the same configuration, a string ST coupled to the first bit line BL1 will be described in detail by way of example.

The string ST may include a source select transistor SST, a plurality of memory cells F1 to F16, and a drain select transistor DST, which are connected in series between the source line SL and the first bit line BL1. One string ST may include one or more source select transistors SST and drain select transistors DST, and may include more memory cells than the memory cells F1 to F16 illustrated in the drawing.

A source of the source select transistor SST may be coupled to the source line SL and a drain of the drain select transistor DST may be coupled to the first bit line BL1. The memory cells F1 to F16 may be connected in series between the source select transistor SST and the drain select transistor DST. Gates of the source select transistors SST included in different strings ST may be coupled to a source select line SSL, gates of the drain select transistors DST may be coupled to a drain select line DSL, and gates of the memory cells F1 to F16 may be coupled to a plurality of word lines WL1 to WL16. A group of memory cells coupled to the same word line, among the memory cells included in different strings ST, may be referred to as a “physical page PPG.” Therefore, a number of physical pages PPG that are identical to the number of word lines WL1 to WL16 may be included in the memory block 11.

One memory cell may store one bit of data. This is typically referred to as a “single-level cell (SLC).” In this case, one physical page PPG may store data corresponding to one logical page LPG. The data corresponding to one logical page LPG may include a number of data bits identical to the number of cells included in one physical page PPG. Further, one memory cell may store two or more bits of data. This cell is typically referred to as a “multi-level cell (MLC)”. Here, one physical page PPG may store data corresponding to two or more logical pages LPG.

FIG. 5 is a diagram illustrating an example of a memory block having a three-dimensional (3D) structure.

Referring to FIG. 5, a memory cell array 10 may include a plurality of memory blocks MB1 to MBk 11. Each of the memory blocks 11 may include a plurality of strings ST11 to ST1m and ST21 to ST2m. In an embodiment, each of the strings ST11 to ST1m and ST21 to ST2m may be formed in a ‘U’ shape. In the first memory block MB1, m strings may be arranged in a row direction (e.g., X direction). Although, in FIG. 5, two strings are illustrated as being arranged in a column direction (e.g., Y direction), this embodiment is given for convenience of description, and three or more strings may be arranged in the column direction (e.g., Y direction) in other embodiments.

Each of the plurality of strings ST11 to ST1m and ST21 to ST2m may include at least one source select transistor SST, first to nth memory cells MC1 to MCn, a pipe transistor PT, and at least one drain select transistor DST.

The source and drain select transistors SST and DST and the memory cells MC1 to MCn may have a similar structure. For example, each of the source and drain select transistors SST and DST and the memory cells MC1 to MCn may include a channel layer, a tunnel insulating layer, a charge trap layer, and a blocking insulating layer. For example, a pillar for providing the channel layer may be provided in each string. For example, a pillar for providing at least one of the channel layer, the tunnel insulating layer, the charge trap layer, and the blocking insulating layer may be provided in each string.

The source select transistor SST of each string may be coupled between a source line SL and memory cells MC1 to MCp.

In an embodiment, source select transistors of strings arranged in the same row may be coupled to a source select line extending in the row direction, and source select transistors of strings arranged in different rows may be coupled to different source select lines. In FIG. 5, the source select transistors of the strings ST11 to ST1m in a first row may be coupled to a first source select line SSL1. The source select transistors of the strings ST21 to ST2m in a second row may be coupled to a second source select line SSL2.

In other embodiments, the source select transistors of the strings ST11 to ST1m and ST21 to ST2m may be coupled in common to one source select line.

The first to n-th memory cells MC1 to MCn in each string may be coupled between the source select transistor SST and the drain select transistor DST.

The first to nth memory cells MC1 to MCn may be divided into first to p-th memory cells MC1 to MCp and p+1-th to n-th memory cells MCp+1 to MCn. The first to p-th memory cells MC1 to MCp may be sequentially arranged in a vertical direction (e.g., Z direction), and may be coupled in series between the source select transistor SST and the pipe transistor PT. The p+1-th to n-th memory cells MCp+1 to MCn may be is sequentially arranged in the vertical direction (e.g., Z direction), and may be coupled in series between the pipe transistor PT and the drain select transistor DST. The first to p-th memory cells MC1 to MCp and the p+1-th to n-th memory cells MCp+1 to MCn may be coupled to each other through the pipe transistor PT. Gates of the first to n-th memory cells MC1 to MCn of each string may be coupled to first to n-th word lines WL1 to WLn, respectively.

In an embodiment, at least one of the first to n-th memory cells MC1 to MCn may be used as a dummy memory cell. When the dummy memory cell is provided, the voltage or current of the corresponding string may be stably controlled. A gate of the pipe transistor PT of each string may be coupled to a pipeline PL.

The drain select transistor DST of each string may be coupled between the corresponding bit line and the memory cells MCp+1 to MCn. Strings arranged in the row direction may be coupled to the corresponding drain select line extending in the row direction. The drain select transistors of the strings ST11 to ST1m in the first row may be coupled to a drain select line DSL1. The drain select transistors of the strings ST21 to ST2m in the second row may be coupled to a second drain select line DSL2.

The strings arranged in the column direction may be coupled to bit lines extending in the column direction. In FIG. 5, the strings ST11 and ST21 in a first column may be coupled to a first bit line BL1. The strings ST1m and ST2m in an m-th column may be coupled to an m-th bit line BLm,

Among strings arranged in the row direction, memory cells coupled to the same word line may constitute one page. For example, memory cells coupled to the first word line WL1, among the strings ST11 to ST1m in the first row, may constitute one page. Among the strings ST21 to ST2m in the second row, memory cells coupled to the first word line WL1 may constitute one additional page. Strings arranged in the direction of a single row may be selected by selecting any one of the drain select lines DSL1 and DSL2. One page may be selected from the selected strings by selecting any one of the word lines WL1 to WLn.

FIG. 6 is a diagram illustrating an example of a memory block having a 3D structure according to an embodiment of the present disclosure.

Referring to FIG. 6, a memory cell array 10 may include a plurality of memory blocks MB1 to MBk 11. Each of the memory blocks 11 may include a plurality of strings ST11′ to ST1m′ and ST21′ to ST2m′. Each of the strings ST11′ to ST1m′ and ST21′ to ST2m′ may extend along a vertical direction (e.g., in a Z direction). In the memory block 11, m strings may be arranged in a row direction (e.g., X direction). Although, in FIG. 6, two strings are illustrated as being arranged in a column direction (e.g., Y direction), this embodiment is given for convenience of description, and three or more strings may be arranged in the column direction (e.g., Y direction) in other embodiments.

Each of the strings ST11′ to ST1m′ and ST21′ to ST2m′ may include at least one source select transistor SST, first to n-th memory cells MC1 to MCn, and at least one drain select transistor DST.

The source select transistor SST of each string may be coupled between a source line SL and the memory cells MC1 to MCn. Source select transistors of strings arranged in the same row may be coupled to the same source select line. The source select transistors of the strings ST11′ to ST1m′ arranged in a first row may be coupled to a first source select line SSL1. The source select transistors of the strings ST21′ to ST2m′ arranged in a second row may be coupled to a second source select line SSL2. In an embodiment, the source select transistors of the strings ST11′ to ST1m′ and ST21′ to ST2m′ may be coupled in common to a single source select line.

The first to n-th memory cells MC1 to MCn in each string may be coupled in series between the source select transistor SST and the drain select transistor DST. Gates of the first to n-th memory cells MC1 to MCn may be coupled to first to n-th word lines WL1 to WLn, respectively.

In an embodiment, at least one of the first to n-th memory cells MC1 to MCn may be used as a dummy memory cell. When the dummy memory cell is provided, the voltage or current of the corresponding string may be stably controlled. Thus, the reliability of data stored in the memory block 11 may be improved.

The drain select transistor DST of each string may be coupled between the corresponding bit line and the memory cells MC1 to MCn. The drain select transistors DST of strings arranged in the row direction may be coupled to a drain select line extending along the row direction. The drain select transistors DST of the strings ST11′ to ST1m′ in the first row may be coupled to a first drain select line DSL1. The drain select transistors DST of the strings ST21′ to ST2m′ in the second row may be coupled to a second drain select line DSL2.

FIG. 7 is a diagram illustrating data segments received from a host according to an embodiment of the present disclosure.

Referring to FIG. 7, each of a plurality of data segments Seg 0 to Seg 2, received from a host during a write operation of a memory system may have a uniform data size (e.g., 2 KB), and such a uniform data size may be a unit data size required for a program operation of a memory device. Here, ‘KB’ means kilobytes.

The plurality of data segments Seg 0 to Seg 2 may be received together with corresponding host commands, respectively, and may be sequentially received.

FIG. 8 is a diagram illustrating a compressed data segment according to an embodiment of the present disclosure.

For example, FIG. 8 illustrates a compressed data segment generated by compressing together the plurality of data segments Seg 0 to Seg 2 illustrated in FIG. 7.

Referring to FIG. 8, the compressed data segment may have a uniform data size (e.g., 2 KB), and may be divided into a plurality of data regions Comp offset 0 to Comp offset 3. Each data region may have a uniform data size (e.g., 512 B). Here, ‘B’ means bytes.

For example, compressed data Seg 0_comp generated by compressing the first data segment Seg 0 of FIG. 7 may be positioned in the first data region Comp offset 0, compressed data Seg_comp generated by compressing the second data segment Seg 1 of FIG. 7 may be positioned in the second data region Comp offset 1, and compressed data Seg 2_comp generated by compressing the third data segment Seg 2 of FIG. 7 may be positioned at third and fourth data regions Comp offset 2 and 3.

Pieces of compressed data generated by compressing respective data segments may have different data sizes, and may vary depending on the compression classes of respective data segments. The remaining space of each of the plurality of data regions Comp offset 0 to 3, other than the space in which compressed data is stored, may be filled with dummy data.

FIG. 9 is a diagram describing compression classes depending on data compressibility.

Referring to FIG. 9, the compression classes of data segments may be divided into a plurality of compression classes Class 0 to Class 3 depending on a data compression ratio, that is, ratio from the data size of the corresponding data segment to the data size of compressed data.

For example, a case where the compression class of a data segment having a uniform data size (e.g., 2 KB) is 0 means that a compression operation is not performed.

Also, when the compression class of the data segment having a uniform data size (e.g., 2 KB) is 1, compressed data obtained from the result of the compression operation may have a data size that is greater than 50% and less than or equal to 75% of the data size of an original data segment, and the data size of the sum of the compressed data and the dummy data may be 1.5 KB.

Also, when the compression class of the data segment having a uniform data size (e.g., 2 KB) is 2, compressed data obtained from the result of the compression operation may have a data size that is greater than 25% and less than or equal to 50% of the data size of the original data segment, and the data size of the sum of the compressed data and the dummy data may be 1 KB.

Also, when the compression class of the data segment having a uniform data size (e.g., 2 KB) is 3, compressed data obtained from the result of the compression operation may have a data size that is greater than 0% and less than or equal to 25% of the data size of the original data segment, and the data size of the sum of the compressed data and the dummy data may be 0.5 KB.

The data compression sizes depending on the above-described compression classes and the size of the final data may vary in accordance with embodiments.

FIG. 10 is a diagram describing data segment management information.

FIG. 11 is a diagram describing a mapping table.

FIG. 12 is a diagram illustrating a data flow during a write operation.

FIG. 13 is a flowchart of a write operation of a memory system according to an embodiment of the present disclosure.

The write operation of the memory system according to an embodiment of the present disclosure will be described with reference to FIGS. 1 to 13.

In an embodiment of the present disclosure, an example will be described in which a first data segment Seg 0 for a write operation is received together with a host command Host_CMD and is stored in the buffer memory 1230, then a second data segment Seg 1 is received together with the host command Host_CMD and is stored in the buffer memory 1230, after which a third data segment Seg 2 is received together with the host command Host CMD.

First, an operation of receiving the first data segment Seg 0 and storing the same in the data buffer 1232 will be described below.

The host control circuit 1210 may receive the host command Host_CMD corresponding to a write command and the first data segment Seg 0 from the host 1300 at step S1410, transmit the received host command Host_CMD to the processor 1220 and transmit the received first data segment Seg 0 to the buffer memory 1230 (\textcircled{1}).

The processor 1220 of the controller 1200 generates a command queue in response to the host command Host_CMD at step S1420.

The compression information detection circuit 1240 may receive the first data segment Seg 0 from the host 1300 (\textcircled{2}), detect the compression information of the received first data segment Seg 0, and transmit the compression information to the buffer memory 1230 (\textcircled{3})) at step S1430. The compression information may include information about whether it is possible to compress the first data segment Seg 0 and information about the compression class of the first data segment Seg 0.

The buffer management block 1231 of the buffer memory 1230 may receive the first data segment Seg 0 and store the first data segment Seg 0 in an assigned space at step S1440. In an embodiment of the present disclosure, the first data segment Seg 0 is described as being stored in segment index 100 of the buffer management block 1231. Here, the buffer management block 1231 generates data segment management information corresponding to the first data segment Seg 0 based on the compression information received from the compression information detection circuit 1240.

As illustrated in FIG. 10, the data segment management information may include status information Seg_Status, segment index information Seg_Index, information Comp_Status about possibility of compression, information Index_Start about a management index after compression, information Comp_Index_Seg No about a position after compression, and information Comp_Class about a compression class. The status information Seg_Status may indicate a state in which the corresponding data segment has been stored in the assigned segment index of the data buffer 1232, and may be changed from “0” to “1” when the storage of the data segment has been completed. The information Comp_Status about the possibility of compression may indicate whether it is possible to compress the corresponding data segment, and may be is indicated by “1” when compression is possible, whereas it may be indicated by “0” when compression is not possible. The information Index_Start about a management index after compression may indicate a segment index to be managed after a compression operation has been performed. The information Comp_Index_Seg No about a position after compression may indicate the position of a data segment in a compressed data segment generated after the compression operation of compressing the corresponding data segment, and may indicate a plurality of data regions illustrated in FIG. 8. The compression class Comp_Class may indicate the compression class of a data segment when the compression operation of compressing the corresponding data segment is performed, and may be classified into a plurality of compression classes Class 0 to Class 3 depending on the variation from the data size of the corresponding data segment to the data size of compressed data, based on the table of FIG. 9.

For now, data segments to be grouped together with the first data segment Seg 0 are not stored in the data buffer 1232 during the compression operation, and thus the first data segment Seg 0 is stored in the data buffer 1232 to remain in a standby state without being compressed or being transmitted to the memory device 1100.

Thereafter, the second data segment Seg 1 and the third data segment Seg 2 are received from the host 1300 and are then stored in the data buffer 1232. Since the steps of the operation in which the second data segment Seg 1 and the third data segment Seg 2 are received and stored in the data buffer 1232 are identical to the above-described steps S1410 to S1440, detailed descriptions thereof will be omitted.

When the storage of the third data segment Seg 2 in the data buffer 1232 has been completed, the buffer management block 1231 may group data segments, on which a compression operation is to be performed together, based on the compression information of the third data segment Seg 2 and the compression information of the data segments that have been stored in the data buffer 1232 earlier than the third data segment Seg 2 at step S1450.

In an embodiment of the present disclosure, an example in which the first data segment Seg 0, the second data segment Seg 1, and the third data segment Seg 2 are grouped to be compressed into a single compressed data segment is described.

Since the compression classes of the first data segment Seg 0 and the second data segment Seg 1 are 3, the sizes of pieces of compressed data thereof after the compression operation may each be 512 B. Also, since the compression class of the third data segment Seg 2 is 2, the size of compressed data thereof after the compression operation may be 1 KB. Therefore, when the first data segment Seg 0, the second data segment Seg 1, and the third data segment Seg 2 are compressed together, the size of the compressed data segment is 2 KB, and thus the first data segment Seg 0, the second data segment Seg 1, and the third data segment Seg 2 may be grouped. The number of data segments within a single group may be adjusted to a value less than or equal to a preset number in order to prevent a phenomenon in which some data segments stored in the data is buffer 1232 remain without being grouped due to the limitation of the grouping (i.e., the condition that a single compressed data segment has a size of the program data unit). For example, even if the data size of the compressed data segment is less than or equal to 2 KB, a preset number (e.g., 3) of data segments may be grouped.

The group of the first data segment Seg 0, the second data segment Seg 1, and the third data segment Seg 2 may be transmitted to the compression block 1251 (\textcircled{4}). The compression block 1251 may generate a compressed data segment having a uniform data size, such as that illustrated in FIG. 8, by compressing the group of the first data segment Seg 0, the second data segment Seg 1, and the third data segment Seg 2, to an identical data size or different data sizes depending on respective compression classes thereof at step S1460. Depending on the result of the compression operation, pieces of position information Comp offset 0 to 3 of respective data segments may be transmitted to the buffer management block 1231, and thus data segment management information may be updated.

The compressed data segment generated by the compression block 1251 is transmitted to the flash control circuit 1260 (\textcircled{5}). Further, among the data segments stored in the data buffer 1232, data segments on which a compression operation is not performed, may also be transmitted to the flash control circuit 1260 (\textcircled{6}).

The flash control circuit 1260 may generate and output an internal command for controlling the memory device 1100 in response to is the command queue generated by the processor 1220 and transmit the received compressed data segment or uncompressed data segments to the memory device 1100 (\textcircled{7}), thus controlling the program operation of the memory device 1100 at step S1470.

The flash translation layer (FTL) 1221 of the processor 1220 may update the mapping table. For example, as illustrated in FIG. 11, a physical address (PBA) Phyaddr_x mapped to respective logical addresses (LBA) 7000 to 7002 of the first to third data segments Seg 0 to Seg 2 that are received from the host 1300 during a write operation, information Comp Valid about whether respective compression operations are performed on the first to third data segments Seg 0 to Seg 2, information Comp offset about the positions of the first to third data segments Seg 0 to Seg 2 in a compressed data segment, information Comp_Class about compression classes, etc. may be updated and managed in the mapping table. The information Comp_Valid may have a value of “1” when a compression operation is performed.

As described above, in accordance with the embodiments of the present disclosure, a group of data segments received from the host may be compressed together based on the compression information, so that a compressed data segment is generated and stored in the memory device, thus improving the storage capacity of the memory system.

FIG. 14 is a diagram illustrating a data flow during a read operation according to an embodiment of the present disclosure.

FIG. 15 is a flowchart of a read operation of a memory system according to an embodiment of the present disclosure according to an embodiment of the present disclosure.

The read operation of the memory system according to an embodiment of the present disclosure will be described below with reference to FIGS. 1, 11, 14, and 15.

In an embodiment of the present disclosure, an operation of reading a data segment having a logical address (LBA) of 7000 will be described as an example.

A host command Host_CMD corresponding to a read command and a logical address are received from the host at step S1610.

The processor 1220 of the controller 1200 may generate a command queue in response to the host command Host_CMD, map the logical address to a physical address based on the mapping table, determine whether a compression operation has been performed on a data segment corresponding to the received logical address during a write operation to the data segment, and check information Comp_offset about the position of the data segment in a compressed data segment when the compression operation has been performed, at step S1620. Depending on the mapping table of FIG. 11, when the logical address (LBA) is 7000, the compression operation has been performed on the corresponding data segment during a write operation to the corresponding data segment, and the position information Comp_offset is 0.

The flash control circuit 1260 may generate an internal command CMD for controlling the read operation of the memory device 1100 in response to the command queue, and may control the read operation of the memory device 1100 by transmitting the internal command CMD and the physical address to the memory device 1100.

The memory device 1100 may perform a read operation in response to the internal command and the address ADD and transmit the read data segment to the controller 1200 at step S1630 (\textcircled{1}).

Whether a compression operation has been performed on the read data segment during a write operation to the read data segment is determined based on the mapping table at step S1640.

As a result of the determination at step S1640, when the read data segment has been compressed (in case of Yes), the flash control circuit 1260 may mask remaining data segments other than the data segment corresponding to the logical address based on the position information of the data segment corresponding to the logical address within the read data segment, which is compressed, at step S1650. For example, since the data segment corresponding to the logical address of 7000 corresponds to the first data region Comp_offset 0 illustrated in FIG. 8, pieces of data corresponding to the remaining data regions Comp offset 1 to 3 other than the data corresponding to the first data region Comp offset 0 are masked and are transmitted to the decompression block 1252 (\textcircled{2}).

The decompression block 1252 may decompress the data corresponding to the first data region Comp offset 0, and may transmit the decompressed data segment to the data buffer 1232 at step S1660

As a result of the determination at step S1640, when the read data segment is an uncompressed data segment (in case of No), the read data is transmitted to the data buffer 1232 (\textcircled{4}).

The buffer memory 1230 may store the decompressed data segment received from the decompression block 1252 or the read data segment received from the flash control circuit 1260 in the data buffer 1232, and then transmit the stored data segment to the host control circuit 1210 (\textcircled{5}), and the host control circuit 1210 may output the received data segment to the host 1300 (\textcircled{6}) at step S1670.

FIG. 16 is a diagram illustrating an embodiment of a memory system.

Referring to FIG. 16, a memory system 30000 may be embodied in a cellular phone, a smartphone, a tablet PC, a personal digital assistant (PDA) or a wireless communication device. The memory system 30000 may include a memory device 1100 and a controller 1200 capable of controlling the operation of the memory device 1100. The controller 1200 may control a data access operation, e.g., a program, erase, or read operation, of the memory device 1100 under the control of a processor 3100.

Data programmed in the memory device 1100 may be output through a display 3200 under the control of the controller 1200.

A radio transceiver 3300 may send and receive radio signals through an antenna ANT. For example, the radio transceiver 3300 may change a radio signal received through the antenna ANT into a signal which may be processed by the processor 3100. Therefore, the processor 3100 may process a signal output from the radio transceiver 3300 and transmit the processed signal to the controller 1200 or the display 3200. The controller 1200 may program a signal processed by the processor 3100 to the memory device 1100. Furthermore, the radio transceiver 3300 may change a signal output from the processor 3100 into a radio signal, and output the changed radio signal to the external device through the antenna ANT. An input device 3400 may be used to input a control signal for controlling the operation of the processor 3100 or data to be processed by the processor 3100. The input device 3400 may be implemented as a pointing device such as a touch pad, a computer mouse, a keypad or a keyboard. The processor 3100 may control the operation of the display 3200 such that data output from the controller 1200, data from the radio transceiver 3300 or data from the input device 3400 is output through the display 3200.

In an embodiment, the controller 1200 capable of controlling the operation of the memory device 1100 may be implemented as a part of the processor 3100 or a chip provided separately from the processor 3100. Further, the controller 1200 may be implemented through the example of the controller illustrated in FIG. 2.

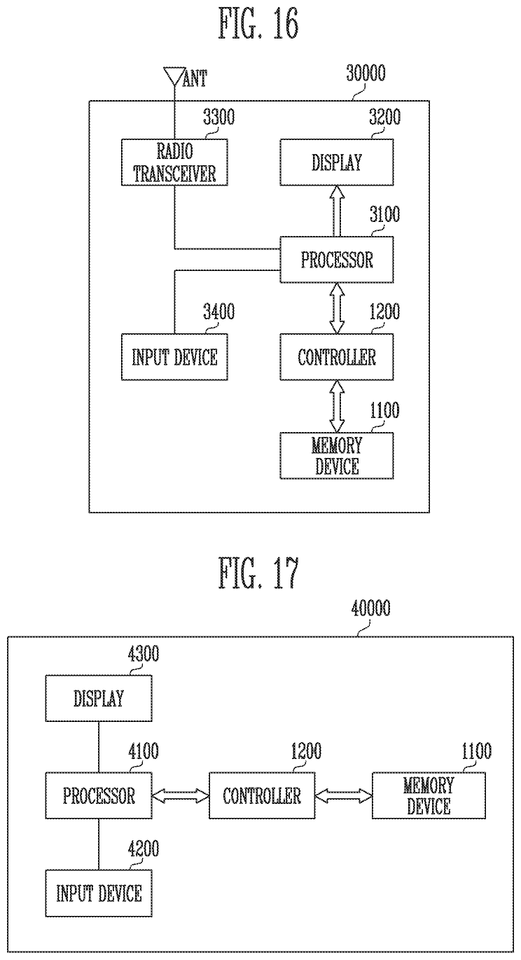

FIG. 17 is a diagram illustrating an embodiment of a memory system.

Referring to FIG. 17, a memory system 40000 may be embodied in a personal computer, a tablet PC, a net-book, an e-reader, a personal digital assistant (PDA), a portable multimedia player (PMP), an MP3 player, or an MP4 player.

The memory system 40000 may include a memory device 1100 and a controller 1200 capable of controlling the data processing operation of the memory device 1100.

A processor 4100 may output data stored in the memory device 1100 through a display 4300, according to data input from an input device 4200. For example, the input device 4200 may be implemented as a pointing device such as a touch pad. a computer mouse, a keypad or a keyboard.

The processor 4100 may control the overall operation of the memory system 40000 and control the operation of the controller 1200. In an embodiment, the controller 1200 capable of controlling the operation of the memory device 1100 may be implemented as a part of the processor 4100 or a chip provided separately from the processor 4100. Further, the controller 1200 may be implemented through the example of the controller illustrated in FIG. 2.

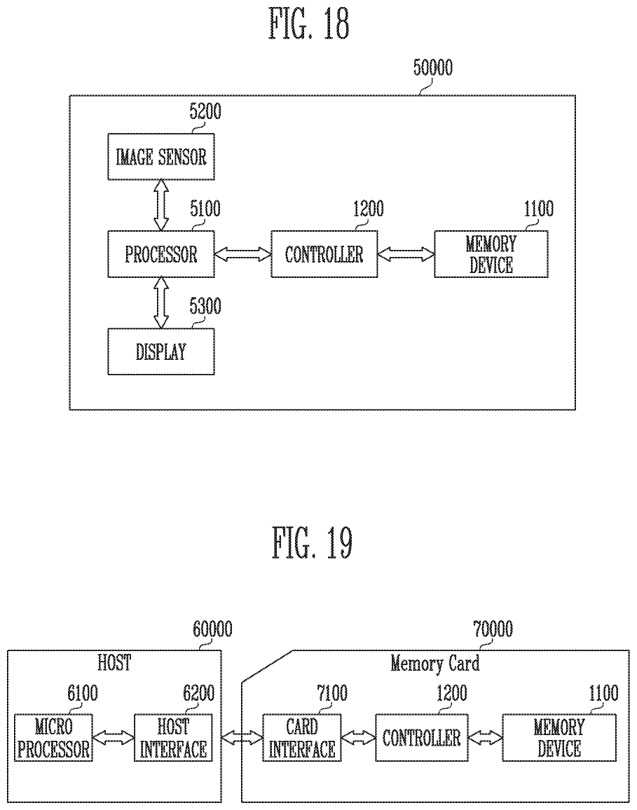

FIG. 18 is a diagram ustrating an embodiment of a memory system.

Referring to FIG. 18, a memory system 50000 may be embodied in an image processing device, e.g., a digital camera, a portable phone provided with a digital camera, a smartphone provided with a digital camera, or a tablet PC provided with a digital camera.

The memory system 50000 may include a memory device 1100 and a controller 1200 capable of controlling a data processing operation, e.g., a program, erase, or read operation, of the memory device 1100.

An image sensor 5200 of the memory system 50000 may convert an optical image into digital signals. The converted digital signals may be transmitted to a processor 5100 or the controller 1200. Under the control of the processor 5100, the converted digital signals may be output through a display 5300 or stored in the memory device 1100 through the controller 1200. Data stored in the memory device 1100 may be output through the display 5300 under the control of the processor 5100 or the controller 1200.

In an embodiment, the controller 1200 capable of controlling the operation of the memory device 1100 may be implemented as a part of the processor 5100, or a chip provided separately from the processor 5100. Further, the controller 1200 may be implemented through the example of the controller illustrated in FIG. 2.

FIG. 19 is a diagram illustrating an embodiment of a memory system.

Referring to FIG. 19, a memory system 70000 may be embodied in a memory card or a smart card. The memory system 70000 may include a memory device 1100, a controller 1200 and a card interface 7100.

The controller 1200 may control data exchange between the memory device 1100 and the card interface 7100. In an embodiment, the card interface 7100 may be a secure digital (SD) card interface or a multi-media card (MMC) interface, but it is not limited thereto. Further, the controller 1200 may be implemented through the example of the controller illustrated in FIG. 2.

The card interface 7100 may interface data exchange between a host 60000 and the controller 1200 according to a protocol of the host 60000. In an embodiment, the card interface 7100 may support a universal serial bus (USB) protocol, and an intership (IC)-USB protocol. Here, the card interface may refer to hardware capable of supporting a protocol which is used by the host 60000, software installed in the hardware, or a signal transmission method.

When the memory system 70000 is coupled to a host interface 6200 of the host 60000 such as a PC, a tablet PC, a digital camera, a digital audio player, a cellular phone, console video game hardware or a digital set-top box, the host interface 6200 may perform data communication with the memory device 1100 through the card interface 7100 and the controller 1200 under the control of a microprocessor 6100.

The present disclosure may check compression information of data segments received from a host and compress the data segments by grouping the data segments, thus efficiently performing a data compression operation and efficiently using the storage space of a memory system.

While the exemplary embodiments of the present disclosure have been disclosed for illustrative purposes, those skilled in the art will appreciate that various modifications, additions and substitutions are possible. Therefore, the scope of the present disclosure must be defined by the appended claims and equivalents of the claims rather than by the description preceding them.

Although the embodiments of the present disclosure have been disclosed, those skilled in the art will appreciate that various modifications, additions and substitutions are possible, without departing from the scope and spirit of the present disclosure.

Therefore, the scope of the present disclosure must be defined by the appended claims and equivalents of the claims rather than by the description preceding them.

In the above-discussed embodiments, all steps may be selectively performed or skipped. In addition, the steps in each embodiment may not always be performed in regular order. Furthermore, the embodiments disclosed in the present specification and the drawings aim to help those with ordinary knowledge in this art more clearly understand the present disclosure rather than aiming to limit the bounds of the present disclosure. In other words, one of ordinary skill in the art to which the present disclosure belongs will be able to easily understand that various modifications are possible based on the technical scope of the present disclosure.

Embodiments of the present disclosure have been described with reference to the accompanying drawings, and specific terms or words used in the description should be construed in accordance with the spirit of the present disclosure without limiting the subject matter thereof. It should be understood that many variations and modifications of the basic inventive concept described herein will still fall within the spirit and scope of the present disclosure as defined in the appended claims and their equivalents.

What is claimed is:

1. A memory system, comprising:
a controller configured to generate a compressed data segment by compressing certain data segments among a plurality of data segments received from a host; and
a memory device configured to receive and store the compressed data segment,
wherein the controller is further configured to detect compression information of each of the plurality of data segments, and
wherein the controller groups together and compresses the certain data segments based on the compression information.

2. The memory system according to claim 1, wherein the controller comprises:
a compression information detection circuit configured to detect the compression information;
a buffer memory configured to store the plurality of data segments and group the certain data segments based on the compression information;
a compression engine configured to generate the compressed data segment by compressing the group of the certain data segments; and
a memory device control circuit configured to transmit the compressed data segment to the memory device and control a program operation of the memory device for the compressed data segment.

3. The memory system according to claim 2, wherein the buffer memory comprises:
a data buffer configured to store the plurality of data segments; and
a buffer management block configured to manage pieces of management information about the plurality of data segments stored in the data buffer and group the certain data segments based on the management information.

4. The memory system according to claim 3,
wherein the buffer management block is further configured to receive the compression information from the compression information detection circuit, and
wherein the buffer management block manages the management information based on the compression information.

5. The memory system according to claim 3, wherein the compression information includes information about whether it is possible to perform a compression operation of compressing a corresponding data segment among the plurality of data segments, and information about a compression class of the corresponding data segment during the compression operation.

6. The memory system according to claim 5, wherein the compression class is classified depending on a compression ratio of the corresponding data segment.

7. The memory system according to claim 6, wherein the buffer management block groups the certain data segments based on compression classes of the plurality of data segments.

8. The memory system according to claim 6, wherein the buffer management block is further configured to select the certain data segments among a plurality of data segments so that the compressed data segment has a predetermined size.

9. The memory system according to claim 5, wherein:
the controller further comprises a processor configured to manage a mapping table, and
the mapping table includes a physical address of the memory device corresponding to a logical address received from the host, information about whether the compression operation has been performed to a data segment corresponding to the logical address, among the plurality of data segments, information about a position of the data segment corresponding to the logical address in the compressed data segment, and information about a compression class of the data segment corresponding to the logical address.

10. The memory system according to claim 1, wherein the compressed data segment includes a plurality of data regions, which correspond to pieces of compressed data obtained by compressing the respective certain data segments.

11. The memory system according to claim 1, wherein the compressed data segment has a size of a program data unit of the memory device.

12. A method of operating a memory system, the method comprising:
detecting compression information of the data segment when a write command and a data segment are received from a host;
generating a command queue corresponding to the write command;
grouping, based on the compression information of the data segment and pieces of compression information of previous data segments that have is been received before the data segment is received, the data segment with certain data segments among the previous data segments;
generating a compressed data segment by compressing the grouped data segments; and
storing the compressed data segment in a memory device in response to the command queue.

13. The method according to claim 12, wherein the compression information includes information about whether it is possible to perform a compression operation of compressing a corresponding data segment among the data segment and the previous data segments, and information about a compression class of the corresponding data segment in the compression operation.

14. The method according to claim 13, wherein the compression class is classified depending on a compression ratio of the corresponding data segment.

15. The method according to claim 14, wherein the grouping of the data segments include grouping the certain data segments with the data segment based on a compression class of the data segment and compression classes of the previous data segments.

16. The method according to claim 14, wherein the grouping of the data segments including grouping the certain data segments with the data segment so that the compressed data segment has a predetermined size.

17. The method according to claim 12, further comprising updating, after the storing of the compressed data segment, information about whether the compression operation has been performed to the certain data segments, information about positions of the certain data segments in the compressed data segment, and information about compression classes of the certain data segments in a mapping table corresponding to the certain data segments.

18. A method of operating a memory system, comprising:
receiving a read command and a logical address from a host and generating a command queue in response to the read command;
checking, based on a mapping table, a physical address of a data segment corresponding to the logical address, information about whether a compression operation of compressing the data segment has been performed during a program operation to the data segment, information about a position of the data segment in a compressed data segment, and information about a compression class of the data segment;
reading the compressed data segment stored in a memory device in response to the command queue and the physical address; and
decompressing the data segment corresponding to the logical address from the compressed data segment based on the information about the position.

19. The method according to claim 18, wherein the compressed data segment includes a plurality of data regions and the position information indicates at least one of the plurality of data regions.

20. The method according to claim 19, wherein the data segment is decompressed from the compressed data segment by masking remaining parts other than the data segment within the compressed data segment according to the information about the position.
